(19) United States
(12) Patent Application Publication
(10) Pub. No.: US 2026/0051159 A1
(43) Pub. Date: Feb. 19, 2026

(54) MODALITY-AGNOSTIC DIFFUSION PROMPTING

(71) Applicant: Cisco Technology, Inc., San Jose, CA (US)

(72) Inventors: Yingjun Du, Amsterdam (NL); Gaowen Liu, Naperville, IL (US); Yuguang Yao, East Lansing, MI (US); Yuzhang Shang, Chicago, IL (US); Charles Fleming, Oxford, MS (US); Ramana Rao V.R. Kompella, Foster City, CA (US)

(73) Assignee: Cisco Technology, Inc., San Jose, CA (US)

(21) Appl. No.: 18/807,198

(22) Filed: Aug. 16, 2024

(51) Int. Cl. G06V 10/82; G06V 10/778

(52) U.S. Cl. CPC G06V 10/82; G06V 10/7788

(57) ABSTRACT

In one implementation, a device determines a set of overfitted prompts for each of a set of samples. The device trains a diffusion model to generate a set of diffusion prompts for each of the set of samples based on the set of overfitted prompts and features of each of the set of samples. The device generates a particular diffusion prompt using the diffusion model for an input sample for a vision-language model. The device inputs the particular diffusion prompt in conjunction with the input sample to the vision-language model to perform a downstream task.

### TECHNICAL FIELD

The present disclosure relates generally to computer networks, and, more particularly, to modality-agnostic diffusion prompting.

### BACKGROUND

Artificial intelligence is rapidly evolving and now capable of performing complex tasks with respect to text, images, video, and the like. In the context of surveillance systems, for instance, artificial intelligence is now used to analyze video in real-time to identify hazardous conditions (e.g., unattended luggage in an airport). Typically, this entails training a specific model to perform the task. For instance, in the case of identifying hazardous conditions captured on video, the model may be trained using a labeled training dataset of example videos depicting those conditions and the lack of those conditions. When multiple tasks are required, each task may necessitate its own labeled training dataset and own trained model, as well.

Recently, generative artificial intelligence has emerged with the ability to generate various forms of content. For instance, a large language model (LLM) may generate text in response to an input prompt that asks a question. One branch of generative artificial intelligence relates to vision-language models (VLMs) that are able to understand both text and images. For example, a user of a VLM may input a prompt of “show me a picture of a cat” and the model would return an image of a cat. However, training a VLM today to perform a specific task still entails first conducting training using a curated and labeled training dataset and then fine-tuning the VLM for different tasks. This can be quite cumbersome both when performing initial training of the VLM to perform a task, as well as when updating the VLM to perform additional tasks.

### BRIEF DESCRIPTION OF THE DRA WINGS

The implementations herein may be better understood by referring to the following description in conjunction with the accompanying drawings in which like reference numerals indicate identically or functionally similar elements, of which:

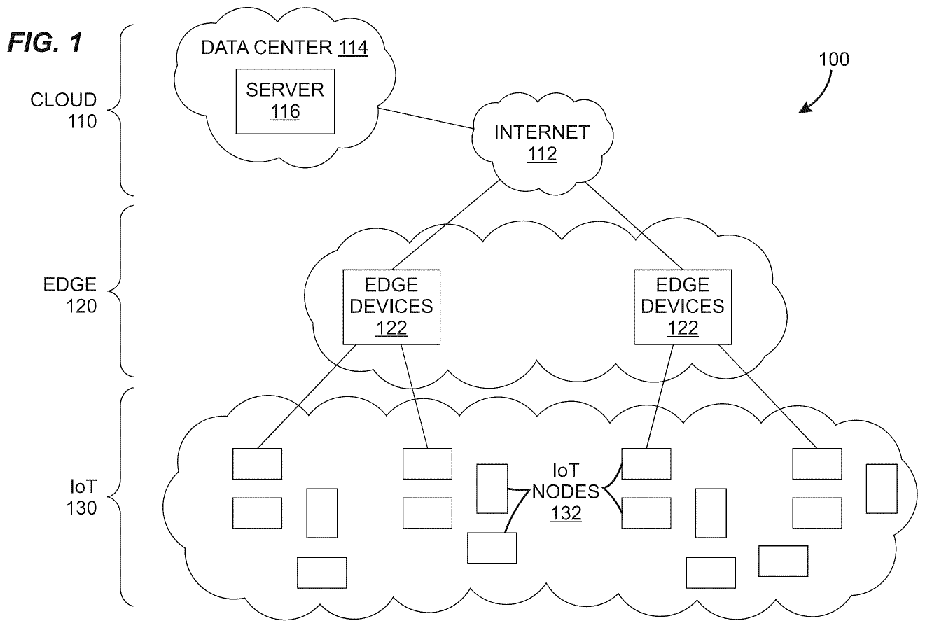

FIG. 1 illustrate an example network;

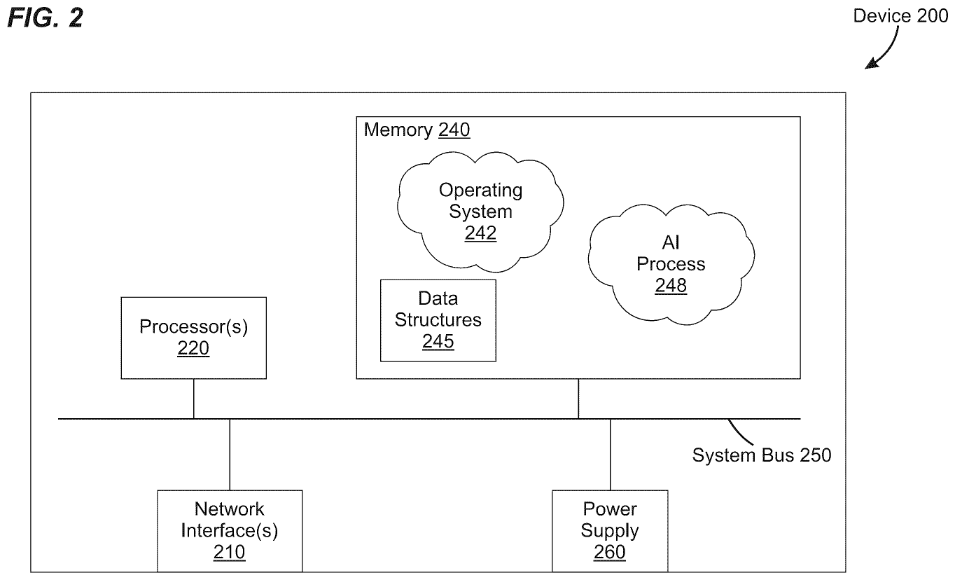

FIG. 2 illustrates an example network device/node;

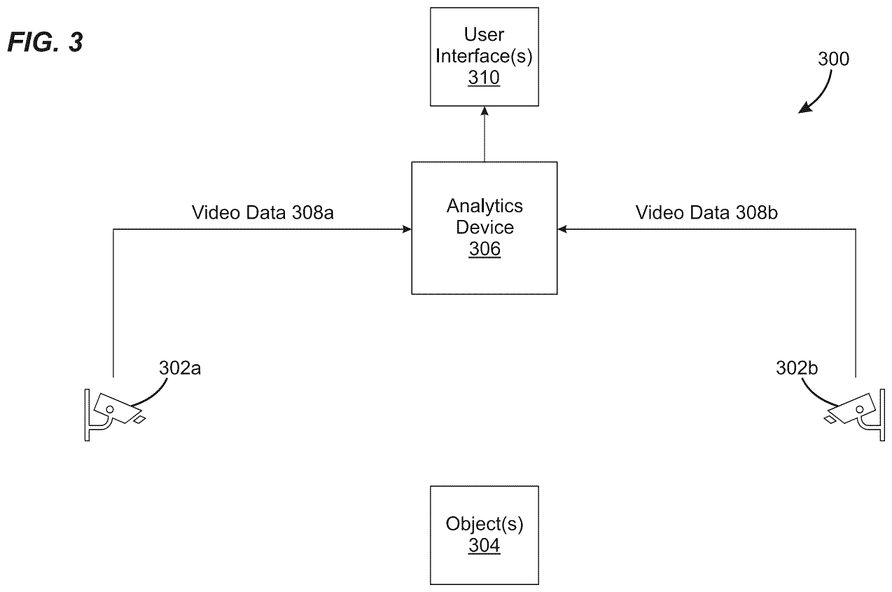

FIG. 3 illustrates an example system for performing video analytics;

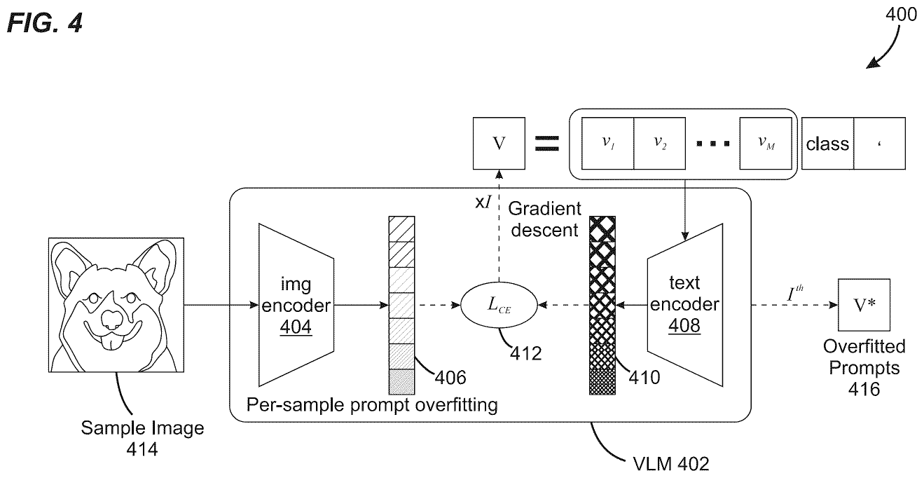

FIG. 4 illustrates an example architecture for generating a set of overfitted prompts;

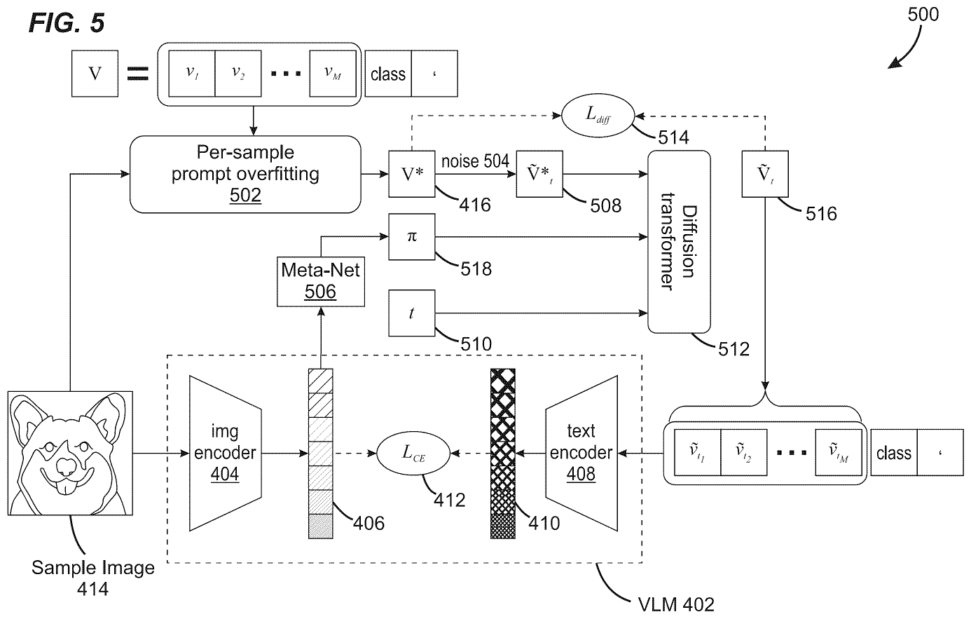

FIG. 5 illustrates an example architecture for performing training using modality-agnostic diffusion prompting;

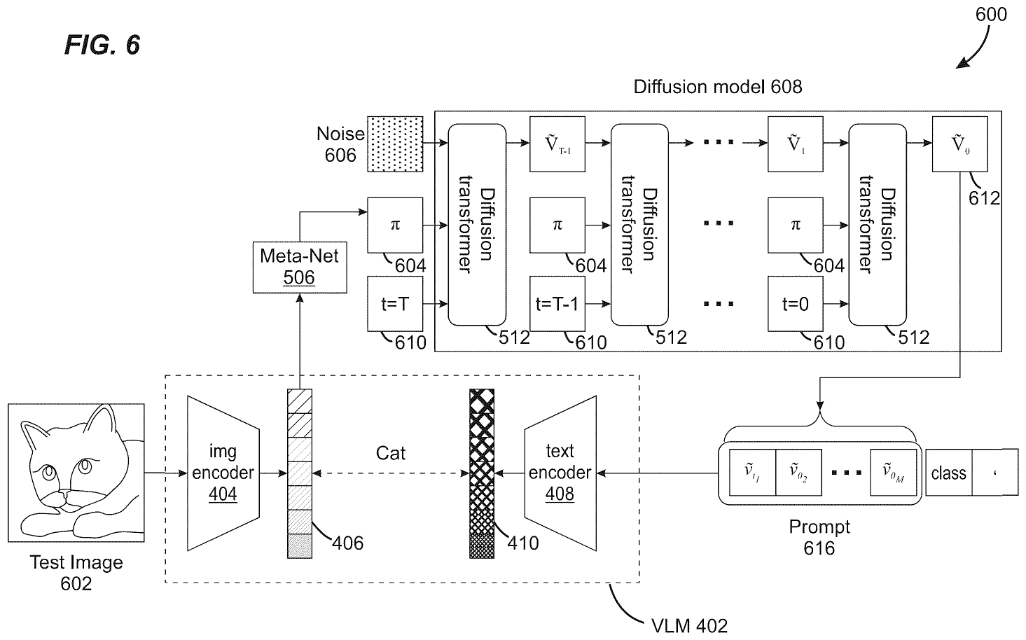

FIG. 6 illustrates an example architecture for using modality-agnostic diffusion prompting in conjunction with a vision-language model (VLM); and

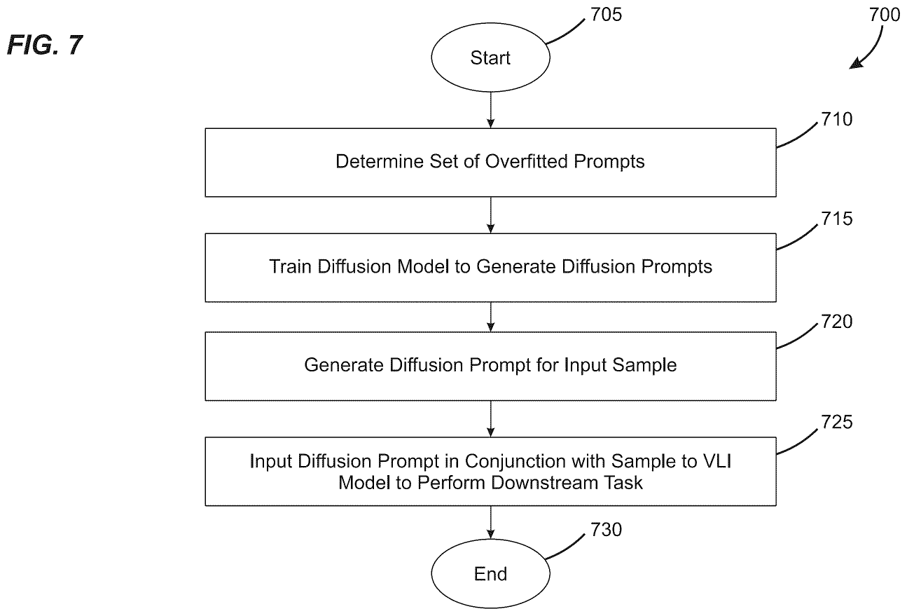

FIG. 7 illustrates an example simplified procedure for performing modality-agnostic diffusion prompting.

### DESCRIPTION OF EXAMPLE IMPLEMENTATIONS

### Overview

According to one or more implementations of the disclosure, a device determines a set of overfitted prompts for each of a set of samples. The device trains a diffusion model to generate a set of diffusion prompts for each of the set of samples based on the set of overfitted prompts and features of each of the set of samples. The device generates a particular diffusion prompt using the diffusion model for an input sample for a vision-language model. The device inputs the particular diffusion prompt in conjunction with the input sample to the vision-language model to perform a downstream task.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IoT” (or “Internet of Everything” or

“IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or wired networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low-rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

FIG. 1 is a schematic block diagram of an example simplified computer network 100 illustratively comprising nodes/devices at various levels of the network, interconnected by various methods of communication. For instance, the links may be wired links or shared media (e.g., wireless links, wired links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.,), or other shared-media protocols where appropriate. In this context, a protocol consists of a set of rules defining how the nodes interact with each other.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative artificial intelligence (AI) process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various implementations, AI process 248 may employ one or more supervised, unsupervised, or self-supervised AI/machine learning models. Generally, supervised learning entails the use of a training set of data that is used to train the model to apply labels to the input data. For example, the training data may include sample video data depicting a particular event that has been labeled as such. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Self-supervised learning models take a middle ground approach that uses a greatly reduced set of labeled training data.

Example techniques that AI process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

In further implementations, AI process 248 may also leverage one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

FIG. 3 illustrates an example system 300 for performing video analytics, as described in greater detail above. As shown, there may be any number of cameras 302 deployed to a physical area, such as cameras 302a-302b. Such surveillance is now fairly ubiquitous across various locations including, but not limited to, public transportation facilities (e.g., train stations, bus stations, airports, etc.), entertainment facilities (e.g., sports arenas, casinos, theaters, etc.), schools, office buildings, and the like. In addition, so-called “smart” cities are also now deploying surveillance systems for purposes of monitoring vehicular traffic, crime, and other public safety events.

Regardless of the deployment location, cameras 302a-302b may generate and send video data 308a-308b, respectively, to an analytics device 306 (e.g., a device 200 executing AI process 248 in FIG. 2). For instance, analytics device 306 may be an edge device (e.g., an edge device 122 in FIG. 1), a remote server (e.g., a server 116 in FIG. 1), or may even take the form of a particular endpoint in the network, such as a dedicated analytics device, a particular camera 302, or the lie.

In general, analytics device 306 may be configured to provide video data 308a-308b for display to one or more user interfaces 310, as well as to analyze the video data for events that may be of interest to a potential user. To this end, analytics device 306 may perform object detection on video data 308a-308b, to detect and track any number of objects 304 present in the physical area and depicted in the video data 308a-308b. In some implementations, analytics device 306 may also perform object re-identification on video data 308a-308b, allowing it to recognize an object 304 in video data 308a as being the same object in video data 308b or vice-versa.

As noted above, AI is rapidly evolving and now capable of performing complex tasks with respect to text, images, video, and the like. For instance, in the case of system 300, analytics device 306 may perform tasks such as analyzing video data 308a and video data 308b for purposes of performing tasks such as object recognition, object re-identification, action recognition (e.g., identifying hazardous conditions), and the like.

Traditionally, a system such as analytics device 306 may leverage AI models, such as convolutional neural networks (CNNs), to perform each of its analytics task. Training of each of these models may entail, for instance, forming training datasets that include video clips that have been labeled as depicting a certain type of object, action, etc. Typically, this entails taking a pre-trained model and fine-tuning that model for the specific task using the appropriate training dataset.

Recently, generative artificial intelligence has emerged with the ability to generate various forms of content. For instance, a large language model (LLM) may generate text in response to an input prompt that asks a question. One branch of generative artificial intelligence relates to vision-language models (VLMs) that are able to understand both text and images. For example, a user of a VLM may input a prompt of “show me a picture of a cat” and the model would return an image of a cat.

However, training a VLM today to perform a specific task (e.g., image classification, action recognition, image segmentation, grounding, etc.) still entails first conducting training using a curated and labeled training dataset and then fine-tuning the VLM for different tasks. This can be quite cumbersome both when performing initial training of the VLM to perform a task, as well as when updating the VLM to perform additional tasks.

### Modality-Agnostic Diffusion Prompting

The techniques herein introduce a modality-agnostic diffusion approach that is agnostic to the specific modality used for a VLM (e.g., image, text, or both image and text). In some aspects, the techniques herein use a diffusion model to form task-specific prompts to fine-tune the VLM to perform a specific task. Such a model may gradually generate the prompts over time to generate prompts tailored to each training sample, enhancing the accuracy of the VLM and its generalization across downstream tasks. In some cases, the techniques herein may be implemented as a plug-and-play architecture that integrated with an existing prompt learning system, whether textual, visual, or multi-modal.

Illustratively, the techniques described herein may be performed by hardware, software, and/or firmware, such as in accordance with AI process 248, which may include computer executable instructions executed by the processor 220 (or independent processor of interfaces 210), to perform functions relating to the techniques described herein.

Specifically, according to various implementations, a device determines a set of overfitted prompts for each of a set of samples. The device trains a diffusion model to generate a set of diffusion prompts for each of the set of samples based on the set of overfitted prompts and features of each of the set of samples. The device generates a particular diffusion prompt using the diffusion model for an input sample for a vision-language model. The device inputs the particular diffusion prompt in conjunction with the input sample to the vision-language model to perform a downstream task.

Operationally, in various implementations, FIG. 4 illustrates an example architecture 400 for generating a set of overfitted prompts. As shown, assume that there is a VLM 402 that is able to process both textual and image prompts, as well as generate outputs in either or both of these modalities. By way of example, one such VLM is Contrastive Language-Image Pre-training (CLIP), although other suitable VLMs are also compatible with the techniques herein. By way of example, VLM 402 may include an image encoder 404 able to form image encodings 406 and a text encoder 408 able to form text embeddings 410. In general, a VLM such as CLIP seeks to train image encoder 404 and text encoder 408 through contrastive pre-training using a large set of paired images and texts. This encourages the encoders to align corresponding image-text pairs in a shared semantic space.

After pre-training, VLM 402 may exhibit the capacity for zero-shot visual recognition by casting classification as an image-text matching task. In such a case, the term “[CLASS]” is used as a placeholder within a prompt template, such as “a photo of a [CLASS]” for text encoder 408. Similarly, “[ACTION]” may be used as a placeholder within a prompt template for action recognition, such as “a photo of a cat doing [ACTION].” Other prompt templates may also exist for further downstream tasks.

In the case of object classification given an input image prompt, letg_{T}(Tᵢ) represent the text features extended for class i. In such a case, the classification probability for class i given an image I is:

$$p ( y = i \vert I ) = \frac{exp ( 〈 {g}_{T} ( {T}_{i} ) , {f}_{I} ( I ) 〉 / τ )}{{\sum }_{j = 1}^{K} exp ( 〈 {g}_{T} ( {T}_{j} ) , {f}_{I} ( I ) 〉 / τ )}$$

where (g_{T}(Tᵢ), f_{I}(I)) denotes the cosine similarity between the image feature f_{I}(I) and the class-specific text feature g_{T}(Tᵢ) for the i^{th} class, K the total number of classes, and τ the ‘temperature’ parameter optimized during the training.

Prompt-based learning enhances the transferability of VLM 402 by avoiding the need for prompt engineering. Instead, it allows for the automatic learning of prompts with a few samples from a downstream task (e.g., images of a cat for purposes of recognizing a cat, etc.). Here, architecture 400 may use prompt-based learning to refine a set of M continuous context vectors V={v₁, v₂, . . . , v_{M}} as the learnable prompt. The prompt Tᵢ={v₁, v₂, . . . , v_{M} . . . cᵢ} is a concatenation of the learnable context vectors V and the class token embedding cᵢ, which is then input to text encoder 408. In some implementations, architecture 400 may tailor context vectors V by minimizing the negative loss-likelihood 412 for the correct class token as follows:

$${ℒ}_{CE} ( V ) = - {\sum }_{i} {y}_{i} log p ( {T}_{i} \vert I )$$

Here, yᵢ denotes the one-hot ground truth label for class i. In downstream tasks, the pre-trained model parameters remain frozen, allowing the learnable prompt vectors V to be efficiently optimized through the minimization of the cross-entropy loss with only a limited number of samples.

In various implementations, architecture 400 may start by seeking to generate a set of overfitted prompts given a set of input samples on a per-sample basis. To do so, architecture 400 may use a minimal number of iterations/using gradient descent. For instance, in the case of a sample image 414, architecture 400 may seek to generate a corresponding overfitted prompt 416 in the form of a textual description of sample image 414 by iteratively performing gradient descent on negative loss-likelihood 412 to optimize the set of prompts.

More specifically, in the case of a sample image x and initial prompts V={v₁, v₂, . . . , v_{M}}, architecture 400 may employ a prompt learning model and iterative gradient descent to optimize the set of prompts, resulting in V*={v₁*, v₂*, . . . , v_{M}*}. These optimized prompts can be considered the ‘optima’ prompts for each sample. Note that the intermediate loss is solely adjusted to achieve overfitted prompts. Afterward, architecture 400 may also discard the gradient information for the learnable prompts with no optimization incorporated into the final loss.

Once architecture 400 has obtained overfitted prompts 416, the objective is then to train the model using random prompts in reference to these overfitted prompts. This is because, during the testing stage, architecture 400 will not have access to the overfitted prompts. Accordingly, in various implementations, architecture 400 may use a diffusion model to learn the generative process of sample-specific prompts, thus boosting the generalization capabilities of the prompts for each sample.

FIG. 5 illustrates an example architecture 500 for performing training using modality-agnostic diffusion prompting, in various implementations. Continuing the example of FIG. 4, again assume that there is VLM 402 and that the system has performed per-sample prompt overfitting 502 as described with respect to FIG. 4, resulting in overfitted prompts 416.

In various implementations, architecture 500 may leverage a diffusion model comprising diffusion transformer 512, to progressively approximate overfitted prompts 416 from a Gaussian noise vector V_{T}˜N(0,I), which possesses the same dimensions as V* (the overfitted prompts 416). This approximation approach iterates through the noise vectors [symbol] (noised prompts 508 formed by injecting noise 504 into overfitted prompts 416) with t (time increment 510) representing the diffusion step from T to 0. This process leads to the reconstruction of V₀, which is anticipated to closely mirror the overfitted prompt associated with the particular sample being analyzed, such as sample image 414.

Specifically, throughout the forward diffusion phase at time increment 510, diffusion transformer 512 may derive overfitted prompts 516 ( [symbol] ). Subsequently, architecture 500 may extract prompt feature π (e.g., image feature 518 of sample image 414) using a lightweight neural network such as Meta-Net 506. In turn, architecture 500 may use noised prompts 508 and image feature 518 to create a conditional token for each input and the temporal timestep t, which are input to diffusion transformer 512.

The results of the above are the interim diffused prompts 516. Architecture 500 then synergizes these prompts with the token [CLASS] and integrated into the text encoder to generate the corresponding text features. The prediction of the final classification outcome for the training image is then conducted using p (y=i|I) above. For each sample, diffusion transformer 512 encapsulates a dual-component objective function comprising the variational lower bound 514 ( [symbol] _{diff}) for diffusion transformer 512 and the cross-entropy loss [symbol] _{CE}.

The objective function, defined as the simplified variational lower bound, aims to accurately predict the denoised overfitted prompts. Formally, the loss function is given by:

$${ℒ}_{diff} = {‖ {V}^{*} - ( \sqrt{\overline{{α}_{t}}} {V}^{*} + \sqrt{1 - {α}_{t}} ϵ , π , t ) ‖}^{2}$$

where [symbol] (.,.,.) denotes the function parameterized by the transformer of diffusion transformer 512. This function processes the image comprising the original overfitted prompts 416, image feature 518, and time increment 510. The efficacy of diffusion transformer 512 is measured by its ability to minimize this loss, thereby accurately reconstructing the overfitted prompts from their noised counterparts. By utilizing [symbol] _{CE}, architecture 500 may derive the final prediction y using the diffused prompts \tilde{V}ₜ. The final objective is shown as follows:

$${ℒ}_{final} = {\sum }_{( x , y )} [ - {Eq}_{( )} [ log p ( y \vert x , {\tilde{V}}_{t} ) ] + β {‖ {V}^{*} - ( \sqrt{\overline{{α}_{t}}} {V}^{*} + \sqrt{1 - {α}_{t}} ϵ , π , t ) ‖}^{2}$$

where β represents a hyperparameter.

By incorporating probabilistic prompts with the diffusion model, this approach balances adaptability and informativeness. Testing has also shown that the techniques herein can be applied to visual prompt tuning (VPT) and multi-modal prompt learning (MaPLe), generating visual prompts through a process identical to that used for generating text prompts, as detailed previously.

FIG. 6 illustrates an example architecture 600 for using modality-agnostic diffusion prompting in conjunction with VLM 402, in various implementations. Continuing the examples in FIGS. 4-5, assume now that the system has obtained overfitted prompts in FIG. 4 and used them to conduct training in FIG. 5, making the system ready for testing and/or post-deployment use.

In general, during the testing phase, the generation of overfitted prompts is infeasible due to the unavailability of test sample labels. Consequently, the diffusion sampling approach may commence with the introduction of Gaussian noise 606 alongside the computed image feature set 604 (π) for a test image 602 by a systematic denoising procedure. Similar to FIG. 5, the system may use Meta-Net 506 to compute feature set 604 for test image 602.

Subsequent to this, the system may draw a noise vector e a standard normal distribution N (0, I). These elements, comprising gaussian noise 606, features set 604, and e, are then input to the diffusion model 608 comprising diffusion transformer 512. Doing so results in [symbol] , the intermediate diffused prompts represented by [symbol] ( [symbol] , π, T), given starting timestep 610 (t=T). In turn, diffusion model 608 may iteratively repeat this over T-number of steps, until producing terminal diffusion prompts 612 ( [symbol] ) where [symbol] = [symbol] .

Upon retrieval of diffusion prompts 612, the system may provide them as prompt inputs 616 to text encoder 408 of VLM 402, causing it to generate pertinent text features for test image 602. The final stage then consists of deploying these features to predict the classification results for test image 602, as delineated by p (y=i|I).

In summary, the techniques herein address the limitations of fixed prompts by introducing an approach that crafts customized prompts for individual samples, enhancing model robustness against distributional shifts. The diffusion model serves as the backbone of this method, enabling a generative process that refines prompts from a random initialization to an optimized state, tailored to each specific instance. The versatility and modality-agnostic nature of diffusion prompting mark it as a universally applicable solution that integrates smoothly with any number of prompt-based classifiers, regardless of the data type. The empirical results from preliminary testing across a wide range of datasets also validates the efficacy of this approach, demonstrating its great performance in generalization tasks.

FIG. 7 illustrates an example simplified procedure (e.g., a method) for performing modality-agnostic diffusion prompting, in accordance with one or more implementations described herein. For example, a non-generic, specifically configured device (e.g., device 200), such as an edge device, a server, or other device in a network, may perform procedure 700 by executing stored instructions (e.g., AI process 248). The procedure 700 may start at step 705, and continues to step 710, where, as described in greater detail above, the device may determine a set of overfitted prompts for each of a set of samples. In some instances, the set of samples comprise images and the set of overfitted prompts comprise textual descriptions of those images.

At step 715, as detailed above, the device may train a diffusion model to generate a set of diffusion prompts for each of the set of samples based on the set of overfitted prompts and features of each of the set of samples. In some implementations, the diffusion model is trained to generate diffusion prompts comprising only textual prompts, only image prompts, and multi-modal prompts that include both text and images. The device may also use a neural network to extract the features of each of the set of samples. In further implementations, the device may also generate a set of noisy prompts by adding noise to the set of overfitted prompts for input to the diffusion model.

At step 720, the device may generate a particular diffusion prompt using the diffusion model for an input sample for a vision-language model, as described in greater detail above. In one implementation, the device may provide a user interface configured to allow a user to select the input sample. In various cases, the vision-language model comprises an image encoder and a text encoder. In one case, the device may also input the particular diffusion prompt to the text encoder of the vision-language model. In various implementations, the device iteratively generates new sets of noisy prompts based on the set of noisy prompts using the diffusion model to set of diffusion prompts.

At step 725, as detailed above, the device may input the particular diffusion prompt in conjunction with the input sample to the vision-language model to perform a downstream task. In various implementations, the downstream task comprises at least one of: image classification, action recognition, image segmentation, or image grounding. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for modality-agnostic diffusion prompting, it is to be understood that various other adaptations and modifications may be made within the spirit and scope of the implementations herein. For example, while certain implementations are described herein with respect to specific use cases for the techniques herein, the techniques can be extended without undue experimentation to other use cases, as well.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof, that cause a device to perform the techniques herein. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
determining, by a device, a set of overfitted prompts for each of a set of samples;
training, by the device, a diffusion model to generate a set of diffusion prompts for each of the set of samples based on the set of overfitted prompts and features of each of the set of samples;
generating, by the device, a particular diffusion prompt using the diffusion model for an input sample for a vision-language model; and
inputting, by the device, the particular diffusion prompt in conjunction with the input sample to the vision-language model to perform a downstream task.

2. The method as in claim 1, wherein the diffusion model is trained to generate diffusion prompts comprising only textual prompts, only image prompts, and multi-modal prompts that include both text and images.

3. The method as in claim 1, wherein the downstream task comprises at least one of: image classification, action recognition, image segmentation, or image grounding.

4. The method as in claim 1, wherein the set of samples comprise images and the set of overfitted prompts comprise textual descriptions of those images.

5. The method as in claim 1, wherein the vision-language model comprises an image encoder and a text encoder.

6. The method as in claim 5, wherein inputting the particular diffusion prompt in conjunction with the input sample to the vision-language model to perform the downstream task comprises:
inputting the particular diffusion prompt to the text encoder of the vision-language model.

7. The method as in claim 1, further comprising:
using, by the device, a neural network to extract the features of each of the set of samples.

8. The method as in claim 1, wherein training the diffusion model comprises:
generating, by the device, a set of noisy prompts by adding noise to the set of overfitted prompts for input to the diffusion model.

9. The method as in claim 8, wherein the device iteratively generates new sets of noisy prompts based on the set of noisy prompts using the diffusion model to set of diffusion prompts.

10. The method as in claim 1, further comprising:
providing, by the device, a user interface configured to allow a user to select the input sample.

11. An apparatus, comprising:
a network interface to communicate with a computer network;
a processor coupled to the network interface and configured to execute one or more processes; and
a memory configured to store a process that is executed by the processor, the process when executed configured to:
determine a set of overfitted prompts for each of a set of samples;
train a diffusion model to generate a set of diffusion prompts for each of the set of samples based on the set of overfitted prompts and features of each of the set of samples;
generate a particular diffusion prompt using the diffusion model for an input sample for a vision-language model; and
input the particular diffusion prompt in conjunction with the input sample to the vision-language model to perform a downstream task.

12. The apparatus as in claim 11, wherein the diffusion model is trained to generate diffusion prompts comprising only textual prompts, only image prompts, and multi-modal prompts that include both text and images.

13. The apparatus as in claim 11, wherein the downstream task comprises at least one of: image classification, action recognition, image segmentation, or image grounding.

14. The apparatus as in claim 11, wherein the set of samples comprise images and the set of overfitted prompts comprise textual descriptions of those images.

15. The apparatus as in claim 11, wherein the vision-language model comprises an image encoder and a text encoder.

16. The apparatus as in claim 15, wherein the apparatus inputs the particular diffusion prompt in conjunction with the input sample to the vision-language model to perform the downstream task by:
inputting the particular diffusion prompt to the text encoder of the vision-language model.

17. The apparatus as in claim 11, wherein the process when executed is further configured to:
use a neural network to extract the features of each of the set of samples.

18. The apparatus as in claim 11, wherein the apparatus trains the diffusion model by:
generating a set of noisy prompts by adding noise to the set of overfitted prompts for input to the diffusion model.

19. The apparatus as in claim 18, wherein the apparatus iteratively generates new sets of noisy prompts based on the set of noisy prompts using the diffusion model to set of diffusion prompts.

20. A tangible, non-transitory, computer-readable medium storing program instructions that cause a device to execute a process comprising:
determining, by the device, a set of overfitted prompts for each of a set of samples;
training, by the device, a diffusion model to generate a set of diffusion prompts for each of the set of samples based on the set of overfitted prompts and features of each of the set of samples;
generating, by the device, a particular diffusion prompt using the diffusion model for an input sample for a vision-language model; and
inputting, by the device, the particular diffusion prompt in conjunction with the =input sample to the vision-language model to perform a downstream task.
